(19) United States
(12) Patent Application Publication
(10) Pub. No.: US 2022/0140369 A1
(43) Pub. Date: May 5, 2022

(54) Fuel Cell System

(71) Applicant: DENSO CORPORATION, Kariya-city (JP)

(72) Inventors: Takashi YAMADA, Kariya-city (JP); Kentarou FUKUDA, Kariya-city (JP); Ryosuke YAMADA, Kariya-city (JP)

(21) Appl. No.: 17/575,379

(22) Filed: Jan. 13, 2022

Related U.S. Application Data
(63) Continuation of application No. PCT/JP2020/022990, filed on Jun. 11, 2020.

(30) Foreign Application Priority Data
Jul. 16, 2019 (JP) 2019-131253

(51) Int. Cl. H01M 8/04492; H01M 8/04082; H01M 8/04089; H01M 8/0438; H01M 8/04828; H01M 8/04746

(52) U.S. Cl. CPC H01M 8/04507; H01M 8/04201; H01M 8/04089; H01M 2008/1095; H01M 8/04828; H01M 8/04753; H01M 8/04395

(57) ABSTRACT

A fuel cell system includes: an upstream side flow path forming a flow path from an oxidation gas supply apparatus toward a fuel cell; and a downstream side flow path forming a flow path from the fuel cell toward an atmosphere. The fuel cell system includes: an oxidation gas pressure sensor that measures a pressure inside the upstream side flow path; and a controller that can execute a water content estimation mode of estimating a water content in an oxidation gas flow path including the fuel cell. The controller includes: a water content calculation unit that calculates the water content in the oxidation gas flow path including the fuel cell on a basis of an oxidation gas flow rate and an oxidation gas pressure loss.

### CROSS REFERENCE TO RELATED APPLICATION

The present application is a continuation application of International Patent Application No. PCT/JP2020/022990 filed on Jun. 11, 2020, which designated the U.S. and claims the benefit of priority from Japanese Patent Application No. 2019-131253 filed on Jul. 16, 2019. The entire disclosures of all of the above applications are incorporated herein by reference.

### TECHNICAL FIELD

The present disclosure relates to a fuel cell system.

### BACKGROUND

A fuel cell monitoring apparatus calculates a water content in a fuel cell, and controls the water content in the fuel cell.

### SUMMARY

According to an aspect of the present disclosure, a fuel cell system includes: a fuel cell that generates power by a chemical reaction between an oxidation gas and a fuel gas; an oxidation gas supply apparatus configured to supply the oxidation gas to the fuel cell; an oxidation gas flow path having an upstream side flow path forming a flow path of the oxidation gas flowing from the oxidation gas supply apparatus toward the fuel cell, and a downstream side flow path forming a flow path of the oxidation gas flowing from the fuel cell toward an exterior space open to an atmosphere; an oxidation gas pressure sensor that measures a pressure inside the upstream side flow path; and a controller configured to execute a water content estimation mode of estimating a water content in an oxidation gas flow path including the fuel cell. The controller includes: a physical quantity acquisition unit that acquires a flow rate of the oxidation gas flowing through the fuel cell, and an oxidation gas pressure in the upstream side flow path; a pressure loss calculation unit that calculates an oxidation gas pressure loss which is a pressure loss of the oxidation gas before and after flowing through the fuel cell on a basis of the oxidation gas pressure in the upstream side flow path and a pressure in the downstream side flow path; and a water content calculation unit that calculates the water content in the oxidation gas flow path including the fuel cell on a basis of the oxidation gas flow rate and the oxidation gas pressure loss.

### BRIEF DESCRIPTION OF DRAWINGS

FIG. 1 is a configuration diagram depicting a fuel cell system.

FIG. 2 is a partial enlarged view depicting an air supply unit.

FIG. 3 is a perspective view depicting the flow rate of air flowing through a fuel cell at the time of normal operation.

FIG. 4 is a perspective view depicting the flow rate of air flowing through a fuel cell at the time of water-clogging.

FIG. 5 is a block diagram related to control of the fuel cell system.

FIG. 6 is a flowchart related to control of the fuel cell system.

FIG. 7 is a flowchart related to processes at Step S100 in FIG. 6.

FIG. 8 is a view depicting a map used for a process at Step S121 in FIG. 7.

FIG. 9 is a flowchart related to control of a fuel cell system in a second embodiment.

FIG. 10 is a flowchart related to processes at Step S200 in FIG. 9.

FIG. 11 is a flowchart related to control of a fuel cell system in a third embodiment.

FIG. 12 is a flowchart related to processes at Step S300 in FIG. 11.

### DESCRIPTION OF EMBODIMENTS

To begin with, examples of relevant techniques will be described.

A fuel cell monitoring apparatus calculates the water content of a fuel cell, and controls the water content in the fuel cell. The fuel cell monitoring apparatus calculates the impedance of the fuel cell by superimposing a signal with a different frequency on an output signal of the fuel cell, and calculates the water content of the fuel cell on the basis of the impedance. The description contents of the citation are incorporated herein by reference as explanations of technical elements in this specification.

In this configuration, a signal with a different frequency is superimposed on an output signal of the fuel cell in order to calculate the water content. Because of this, it is necessary to perform power generation with the fuel cell when the water content is to be calculated. In the respect mentioned above, or in other respects not mentioned, further improvements are demanded about fuel cell systems.

The present disclosure provides a fuel cell system that is capable of scavenging by estimating the water content independently of whether or not power generation is being performed.

The fuel cell system disclosed here includes: a fuel cell that generates power by a chemical reaction between an oxidation gas and a fuel gas; an oxidation gas supply apparatus configured to supply the oxidation gas to the fuel cell; an oxidation gas flow path having an upstream side flow path forming a flow path of the oxidation gas flowing from the oxidation gas supply apparatus toward the fuel cell, and a downstream side flow path forming a flow path of the oxidation gas flowing from the fuel cell toward an exterior space open to an atmosphere; an oxidation gas pressure sensor that measures a pressure inside the upstream side flow path; and a controller configured to execute a water content estimation mode of estimating a water content in an oxidation gas flow path including the fuel cell, and a scavenging mode of lowering the water content in the oxidation gas flow path including the fuel cell. The controller includes: a physical quantity acquisition unit that acquires a flow rate of the oxidation gas flowing through the fuel cell, and an oxidation gas pressure in the upstream side flow path; a pressure loss calculation unit that calculates an oxidation gas pressure loss which is a pressure loss of the oxidation gas before and after flowing through the fuel cell on a basis of the oxidation gas pressure in the upstream side flow path and a pressure in the downstream side flow path; a water content calculation unit that calculates the water content in the oxidation gas flow path including the fuel cell on a basis of the oxidation gas flow rate and the oxidation gas pressure loss; and a scavenging control unit that controls the oxidation gas supply apparatus on a basis of the estimated water content in the scavenging mode.

According to the disclosed fuel cell system, the fuel cell system includes the water content calculation unit that calculates the water content in an oxidation gas flow path including a fuel cell on the basis of an oxidation gas flow rate, and an oxidation gas pressure loss, and in a scavenging mode, the scavenging control unit controls an oxidation gas supply apparatus on the basis of the water content estimated by the water content estimating unit. Because of this, the scavenging mode can be executed by estimating the water content from a change in the flow rate, and pressure loss of an oxidation gas that change depending on a supply of the oxidation gas. Accordingly, it is possible to provide the fuel cell system that is capable of scavenging by estimating the water content independently of whether or not power generation is being performed.

A plurality of aspects disclosed in this specification adopt mutually different technical means in order to achieve each object. Reference characters in parentheses described in claims, and in this section are intended to depict, as examples, correspondences with portions in embodiments mentioned below, but are not intended to limit the technical scope. Objects, features, and advantages disclosed in this specification become clearer by referring to the following detailed explanation, and attached figures.

With reference to the figures, a plurality of embodiments are explained. Functionally and/or structurally corresponding portions, and/or associated portions in the plurality of embodiments are given identical reference characters, or reference characters including the same numerals for the last two digits, and different numerals for other digits in some cases. Explanations of other embodiments can be referred to about the corresponding portions, and/or the associated portions.

### First Embodiment

For example, a fuel cell system 1 is mounted on a fuel cell hybrid vehicle (FCHV), and generates power to be supplied to a drive motor. As a stationary fuel cell system, the fuel cell system 1 takes out electricity and heat simultaneously, and supplies hot water, heats air, and so on. In the following case explained as an example, the fuel cell system 1 is used for a vehicle.

The fuel cell system 1 performs power generation by a chemical reaction between a fuel gas and an oxidation gas in fuel cell units 10. In the following case explained as an example, hydrogen is used as the fuel gas, and air containing oxygen is used as the oxidation gas.

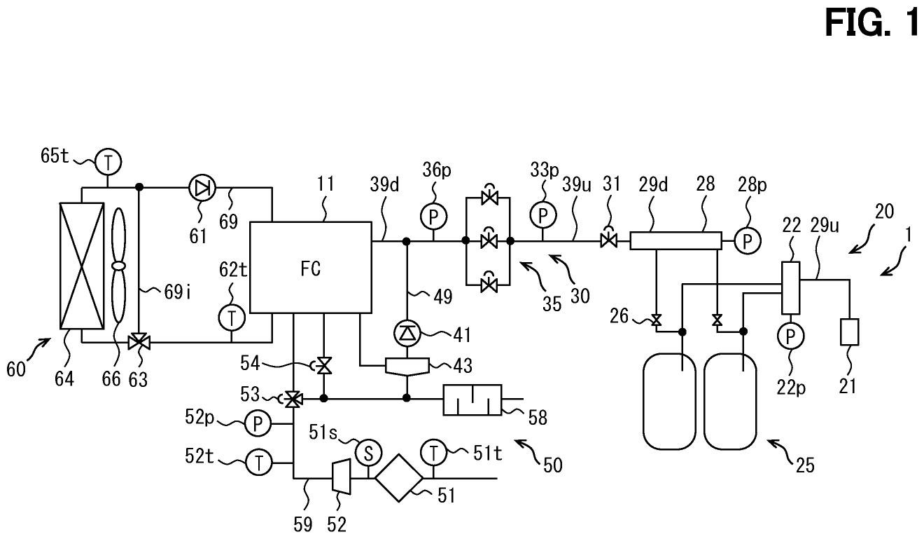

In FIG. 1, the fuel cell system 1 includes a fuel cell 11, a hydrogen supply unit 20, a hydrogen decompression unit 30, an air supply unit 50, and an FC cooling unit 60. The fuel cell 11 includes the fuel cell units 10. Each fuel cell unit 10 includes a cathode on one surface of an electrolyte film that can transmit hydrogen ions, and includes an anode on the other surface. The fuel cell unit 10 is a polymer electrolyte fuel cell that is supplied, at its cathode, with air containing oxygen to function as an oxidant, and is supplied, at its anode, with hydrogen to function as a reductant, to thereby perform power generation by a chemical reaction. The fuel cell 11 includes a plurality of the fuel cell units 10 which overlap one on another via separators. The fuel cell 11 is also called an FC or an FC stack.

The hydrogen supply unit 20 supplies hydrogen, which is a fuel, to the fuel cell 11 in the fuel cell system 1. The hydrogen supply unit 20 includes a filling unit 21, and a hydrogen storage unit 25. The filling unit 21 forms a filling port which is an opening to function as an inlet of hydrogen when the fuel cell system 1 is to be filled with hydrogen from a hydrogen station. The hydrogen storage unit 25 is an apparatus for storing high-pressure hydrogen. The hydrogen storage unit 25 has a plurality of tanks.

The hydrogen supply unit 20 includes a filling flow path 29u that connects the filling unit 21 and the hydrogen storage unit 25, and provides a flow path for hydrogen. The filling flow path 29u includes a distributing unit 22 that distributes hydrogen to each of the plurality of tanks, and causes hydrogen to flow therein. The distributing unit 22 is provided with a filling side pressure sensor 22p for measuring the pressure of hydrogen.

The hydrogen supply unit 20 includes a high-pressure flow path 29d included as part of a flow path for supplying hydrogen from the hydrogen storage unit 25 toward the fuel cell 11. The high-pressure flow path 29d includes tank open/close valves 26 for controlling flows of hydrogen between the hydrogen storage unit 25 and the fuel cell 11. The tank open/close valves 26 are electrically-driven valves whose degrees of opening can be controlled electrically. The tank open/close valves 26 are also called tank shut valves. The high-pressure flow path 29d includes a merging section 28 for merging hydrogen having flowed out of the plurality of tanks toward the fuel cell 11. The merging section 28 is provided with a high-pressure sensor 28p for measuring the pressure of hydrogen.

The hydrogen decompression unit 30 is provided between the hydrogen supply unit 20 and the fuel cell 11. The hydrogen decompression unit 30 is a portion for reducing the pressure of hydrogen in the course of supply of hydrogen to the fuel cell 11 in the fuel cell system 1. The hydrogen decompression unit 30 includes two pressure-reducing apparatuses which are a regulator 31, and an injector 35.

The regulator 31 is an apparatus for reducing the pressure of high-pressure hydrogen having flowed through the high-pressure flow path 29d to an intermediate pressure which is a pressure lower than the high pressure. The regulator 31 is a mechanically-driven valve that keeps the pressure difference between the upstream side and downstream side of the regulator 31 at a predetermined value. It should be noted that an electrically-driven valve whose degree of opening can be controlled electrically may be used as the regulator 31, and the pressure difference between the upstream side and downstream side may be controlled electrically.

The injector 35 is an apparatus that reduces the pressure of hydrogen which has been reduced by the regulator 31, and has become the intermediate pressure to a low pressure which is a pressure lower than the intermediate pressure. The injector 35 includes a plurality of electrically-driven valves whose degrees of opening can be controlled electrically. The plurality of electrically-driven valves are arranged in parallel. For example, the injector 35 includes three electrically-driven valves. The injector 35 functions as an apparatus for controlling the amount of hydrogen to be caused to flow to the fuel cell 11. In other words, in case where the amount of hydrogen consumed by the fuel cell 11 is small, the number of valves to be opened in the valves included in the injector 35 is reduced. On the other hand, in case where the amount of hydrogen consumed by the fuel cell 11 is large, the number of valves to be opened in the valves included in the injector 35 is increased. In this manner, the amount of hydrogen to be caused to flow to the fuel cell 11 is controlled by controlling the number of valves to be opened in the plurality of the valves included in the injector 35.

The hydrogen decompression unit 30 includes an intermediate-pressure flow path 39u that connects the high-pressure flow path 29d and the injector 35, and provides a flow path for hydrogen. The regulator 31 is positioned on the boundary between the high-pressure flow path 29d and the intermediate-pressure flow path 39u. The intermediate-pressure flow path 39u is provided with an intermediate-pressure sensor 33p for measuring the pressure of hydrogen.

The hydrogen decompression unit 30 includes a low-pressure flow path 39d that connects the intermediate-pressure flow path 39u and the fuel cell 11, and provides a flow path for hydrogen. The injector 35 is positioned on the boundary between the intermediate-pressure flow path 39u and the low-pressure flow path 39d. The low-pressure flow path 39d is provided with a low-pressure sensor 36p for measuring the pressure of hydrogen.

In the fuel cell system 1, hydrogen flows through the high-pressure flow path 29d, the intermediate-pressure flow path 39u, and the low-pressure flow path 39d in this order toward the fuel cell 11 while its pressure is lowered stepwise. It should be noted that steps at which the pressure of hydrogen is lowered are not limited to the three steps including the high pressure, the intermediate pressure, and the low pressure.

The fuel cell system 1 includes a hydrogen circulating section for circulating hydrogen having not used for a chemical reaction in the fuel cell 11. The hydrogen circulating section includes a hydrogen pump 41, and a drain valve 43. The hydrogen pump 41 is a fluid transporting apparatus for sucking in hydrogen having flowed out of the fuel cell 11, and causing the hydrogen to return to the low-pressure flow path 39d. The hydrogen pump 41 is an electrically-driven pump whose magnitude of output power can be controlled electrically. The drain valve 43 is an apparatus for draining water generated by a chemical reaction between hydrogen and oxygen in the fuel cell 11. In some cases, the drain valve 43 discharges also hydrogen partially, simultaneously when water is drained.

The hydrogen circulating section includes a hydrogen circulation flow path 49 that connects the fuel cell 11, the hydrogen pump 41 and the drain valve 43, and through which a fluid such as hydrogen flow. The hydrogen circulation flow path 49 is included in a flow path through which a fluid circulates, and that connects a portion of the fuel cell 11 where hydrogen, and water flow out and the low-pressure flow path 39d.

The air supply unit 50 is a portion for supplying air containing oxygen which is an oxidant to the fuel cell 11 in the fuel cell system 1. Configurational details of the air supply unit 50 are explained later.

The FC cooling unit 60 is a portion for cooling the fuel cell 11, which generates heat along with power generation in the fuel cell system 1. The FC cooling unit 60 includes a cooling water pump 61, a radiator 64, and a blower 66. The cooling water pump 61 is a pump for causing cooling water to flow to the fuel cell 11. The cooling water pump 61 is an electrically-driven pump whose magnitude of output power can be controlled electrically. Instead of the cooling water, a refrigerant that cools fuel cell 11 by using phase transitions between the gas phase and the liquid phase may be used as a cooling heat transfer medium. The cooling heat transfer medium is not limited to a liquid like the cooling water, but a gas may be used.

The radiator 64 is an apparatus for cooling the cooling water by causing the cooling water, and air to exchange heat. The blower 66 is an apparatus that controls the amount of air to flow through the radiator 64, and controls the cooling effect of the cooling water by the radiator 64. The blower 66 is an electrically-driven blower whose rotation speed can be controlled electrically.

The FC cooling unit 60 includes a cooling flow path 69 that annularly connects the fuel cell 11, the cooling water pump 61, and the radiator 64. The cooling flow path 69 includes a cooling water bypass flow path 69i for circulating the cooling water to the fuel cell 11 bypassing the radiator 64. The cooling water bypass flow path 69i is provided with a cooling water bypass valve 63 that controls the amount of the cooling water to flow to the cooling water bypass flow path 69i.

The cooling flow path 69 is provided with a high-temperature sensor 62t on the downstream side of the fuel cell 11, and on the upstream side of the cooling water bypass valve 63, in terms of a flow of the cooling water. The high-temperature sensor 62t is a sensor that measures the temperature of the cooling water that has become high by being heated as a result of heat exchange with the fuel cell 11, which is a heat-generating component. The temperature of the fuel cell 11 can be estimated from the temperature measured by the high-temperature sensor 62t. The cooling flow path 69 is provided with a low-temperature sensor 65t on the downstream side of the radiator 64, and on the upstream side of a portion of connection with the cooling water bypass flow path 69i in the cooling flow path 69, in terms of the flow of the cooling water. The low-temperature sensor 65t is a sensor that measures the temperature of the cooling water having become low by being cooled as a result of heat exchange with the radiator 64. The temperature of the radiator 64 can be estimated from the temperature measured by the low-temperature sensor 65t.

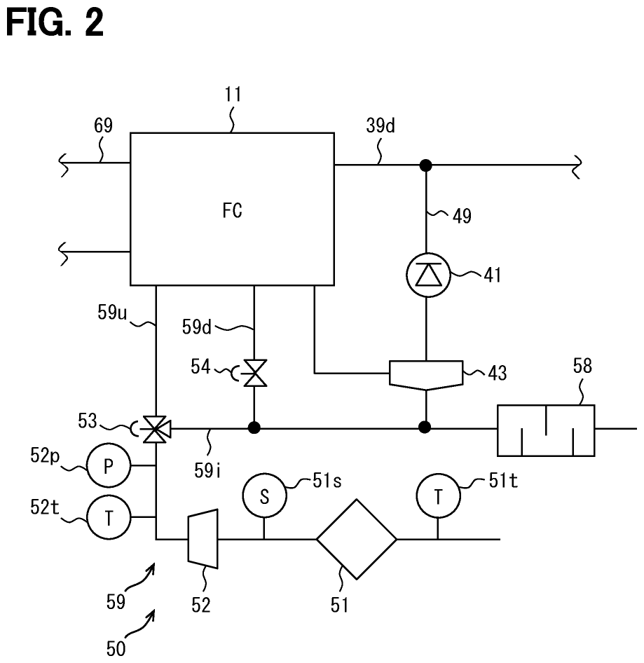

Configurational details of the air supply unit 50 are explained below. In FIG. 2, the air supply unit 50 includes an air cleaner 51, and an air compressor 52. The air cleaner 51 is an apparatus for removing foreign matters included in air. A filter is provided inside the air cleaner 51, and removes foreign matters from air that passes through the air cleaner 51. The air compressor 52 is an apparatus that compresses air that have been sucked in, and feeds the air to the fuel cell 11. The air compressor 52 is an electrically-driven compressor running control can be controlled electrically. The air compressor 52 provides an example of an oxidation gas supply apparatus. Instead of the air compressor 52, an air-feeding apparatus may function as the oxidation gas supply apparatus.

The air supply unit 50 includes an air flow path 59 that connects the fuel cell 11, the air cleaner 51, and the air compressor 52, and through which a fluid such as air flows. The air flow path 59 includes an upstream side flow path 59u which is a flow path that supplies air to the fuel cell 11, and a downstream side flow path 59d which is a flow path that discharges the air having flowed through the fuel cell 11 to the outside. The downstream side flow path 59d is provided with a muffler 58. The muffler 58 is an apparatus for appropriately discharging a fluid from the inside of the fuel cell system 1 to the outside. The air flow path 59 provides an example of an oxidation gas flow path.

The downstream side flow path 59d is connected with the drain valve 43. Because of this, after water and hydrogen discharged from the drain valve 43, and air having flowed through the fuel cell 11 merged, the water, hydrogen, and air pass through the muffler 58, and are discharged to an exterior space open to the atmosphere.

The air flow path 59 includes an air bypass flow path 59i that causes air to flow to the muffler 58 bypassing the fuel cell 11. The upstream side flow path 59u is provided with a divergence valve 53 that controls the amount of air to be caused to flow to the air bypass flow path 59i. The divergence valve 53 increases the amount of air to flow to the air bypass flow path 59i in case where the amount of hydrogen discharged from the drain valve 43 is large. Thereby, the concentration of hydrogen discharged to the outside is hindered from being excessively high by diluting hydrogen discharged from the muffler 58 to the outside. The downstream side flow path 59d is provided with a pressure regulating valve 54. The amount of air to be supplied to the fuel cell 11 is adjusted by controlling the degree of opening of the pressure regulating valve 54. The pressure regulating valve 54 closes the flow path when the fuel cell system 1 has stopped being driven, and thereby the pressure regulating valve 54 can fulfill its functionality of hindering oxidation in the fuel cell 11. The divergence valve 53, and the pressure regulating valve 54 are electrically-driven valves whose degrees of opening can be controlled electrically.

The divergence valve 53 may include not only one valve for switching between a flow path to the fuel cell 11, and a flow path to the air bypass flow path 59i. For example, the divergence valve 53 may include two valves which are a valve for opening/closing the flow path to the fuel cell 11, and a valve for opening/closing the flow path to the air bypass flow path 59i. The air bypass flow path 59i provides an example of an oxidation gas bypass flow path. The divergence valve 53 provides an example of an oxidation gas bypass valve.

In another possible configuration, the air bypass flow path 59i may not be included. In this case, air discharged from the air compressor 52 necessarily flows through the fuel cell 11. If this configuration is adopted, the air bypass flow path 59i can be omitted, and valves such as the divergence valve 53 or the pressure regulating valve 54 can be omitted. Because of this, the configuration of the air supply unit 50 can be simplified easily.

The upstream side flow path 59u is provided with an intake-air-temperature sensor 51t that measures the temperature of intake air which is air to be compressed at the air compressor 52. The intake-air-temperature sensor 51t is provided on the upstream side of the air cleaner 51, in terms of a flow of air. The upstream side flow path 59u is provided with an air flow meter 51s for measuring the flow rate of intake air. The air flow meter 51s is provided between the air cleaner 51 and the air compressor 52.

The upstream side flow path 59u is provided with a supply air temperature sensor 52t. The supply air temperature sensor 52t measures the temperature of air having been compressed by the air compressor 52. The supply air temperature sensor 52t is provided between the air compressor 52 and the divergence valve 53. It should be noted that the supply air temperature sensor 52t may be provided between the divergence valve 53 and the fuel cell 11. The supply air temperature sensor 52t provides an example of an upstream-side temperature sensor.

The upstream side flow path 59u is provided with an air pressure sensor 52p that measures an air pressure on the downstream side of the air compressor 52, and on the upstream side of the divergence valve 53, in terms of a flow of air. The air pressure sensor 52p measures the pressure of air discharged from the air compressor 52. The air pressure sensor 52p is provided between the air compressor 52 and the divergence valve 53. It should be noted that the air pressure sensor 52p may be provided between the divergence valve 53 and the fuel cell 11. The air pressure sensor 52p provides an example of an oxidation gas pressure sensor.

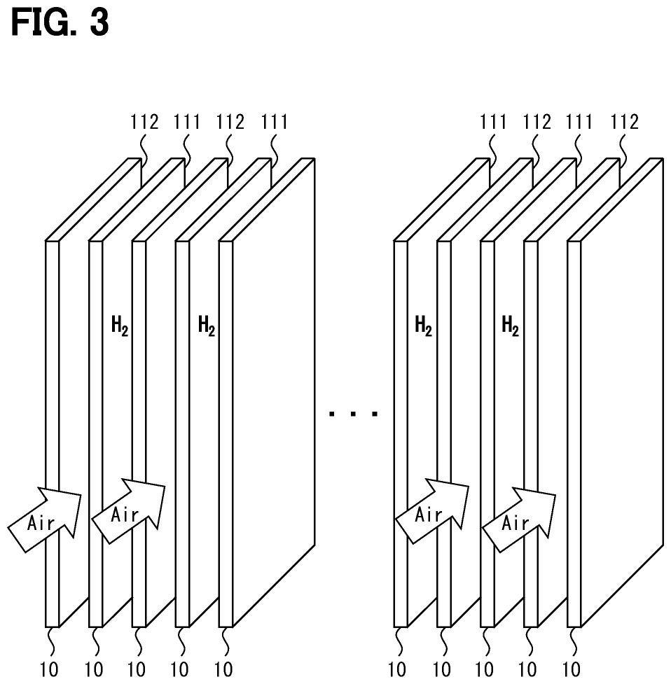

In FIG. 3, the plurality of fuel cell units 10 are arranged being stacked one on another at constant intervals. One surface of each fuel cell unit 10 other than fuel cell units 10 positioned at both ends forms an inter-cell hydrogen flow path 111 for supplying hydrogen to the fuel cell unit 10. The other surface of each fuel cell unit 10 forms an inter-cell air flow path 112 for supplying air to the fuel cell unit 10. In other words, each fuel cell unit 10 is configured being sandwiched by two flow paths which are the inter-cell hydrogen flow path 111 and the inter-cell air flow path 112.

Arrows in FIG. 3 represent flows of air to be supplied to the fuel cell 11 by the air compressor 52. The flow path areas of the inter-cell air flow paths 112 are equal to each other. Because of this, air is evenly distributed to the fuel cell units 10. In this state, the fuel cell units 10 can be supplied with air appropriately. Accordingly, the fuel cell 11 can generate power efficiently in this state. In other words, the fuel cell 11 is operating normally in this state.

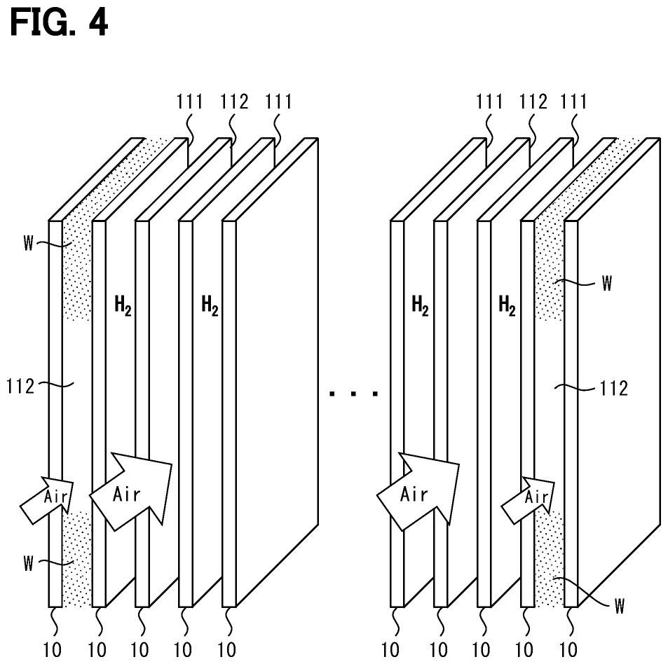

In FIG. 4, water W is accumulated in some inter-cell air flow paths 112. In other words, water-clogging has occurred in the fuel cell 11 in this state. The water W is generated by a chemical reaction between hydrogen and oxygen. The generated water is concentrated at the inter-cell air flow paths 112 which are on the sides where oxygen is supplied. The water W is condensed water generated as a result of cooling of air supplied to the fuel cell 11 on the front surfaces of the fuel cell units 10, and as a result of condensation of moisture contained in the air. The condensed water is concentrated at the inter-cell air flow paths 112 which are on the sides where the air containing the moisture is supplied. The water W generated for such reasons undesirably stays at the inter-cell air flow paths 112, and thereby closes parts of the inter-cell air flow paths 112. Thereby, the area of the inter-cell air flow paths 112 where air can be distributed decreases.

Arrows in FIG. 4 represent flows of air to be supplied to the fuel cell 11 by the air compressor 52. A larger amount of air flows through inter-cell air flow paths 112 where the water W is not accumulated than through inter-cell air flow paths 112 where the water W is accumulated. In this state, the supply amount of air becomes excessively small for some fuel cell units 10, and there are fuel cell units 10 that cannot generate power appropriately. In other words, there are differences between power generation amounts of the fuel cell units 10 in this state.

The state where the amount of the water W accumulated in the inter-cell air flow paths 112 is large is a state where the water content is large. As the water content increases, flow paths of air become narrower, and so the pressure loss increases. It should be noted that by causing air to flow through the inter-cell air flow paths 112, it is possible to remove the water W accumulated in the inter-cell air flow paths 112. The process of causing air to flow for removing water or foreign matters accumulated in the inter-cell air flow paths 112 is called scavenging. Scavenging includes a form in which air is caused to flow to the fuel cell 11 in a state where the fuel cell 11 is not generating power. Scavenging includes a form in which an amount of air which is more than necessary for power generation is caused to flow to the fuel cell 11 in a state where the fuel cell 11 is generating power. Similarly to the inter-cell air flow paths 112, if water is accumulated in the air flow path 59, the flow path of air becomes narrow, and so the pressure loss increases. By executing scavenging, water or the like accumulated in flow paths of air other than the inter-cell air flow paths 112 can also be removed. In other words, scavenging includes a form in which air is caused to flow to a flow path including the fuel cell 11 for the purpose of removing water or the like accumulated in the air flow path 59. The water content means the amount of water included in the fuel cell 11, and the air flow path 59. In other words, the water content is the amount of water included in the whole of the fuel cell system 1. It should be noted that only an amount of water included in the fuel cell 11 may be handled as the water content.

If the water content is excessively small in the fuel cell 11, a chemical reaction between hydrogen and oxygen is not caused appropriately, and the power generation efficiency lowers. On the other hand, in a so-called flooding state where the water content is excessively large, an appropriate amount of air cannot be supplied to the fuel cell units 10. Because of this, a chemical reaction between hydrogen and oxygen is not caused appropriately, and the power generation efficiency lowers. In summary, when the fuel cell 11 performs power generation, a state where an appropriate water content is maintained in the fuel cell 11 is preferred.

There is a possibility that moisture of the fuel cell 11 is frozen if the temperature of the fuel cell 11 is lowered excessively. Because of this, in case where the state where the fuel cell 11 does not perform power generation lasts long, the water content of the fuel cell 11 is reduced to prevent the freezing of the moisture preferably. In other words, while the fuel cell system 1 has stopped being driven, it is preferred to maintain the state where the water content of the fuel cell 11 is small, and the fuel cell 11 is dry. In this manner, in the fuel cell system 1, it is very important to appropriately grasp the latest water content independently of the power generation state.

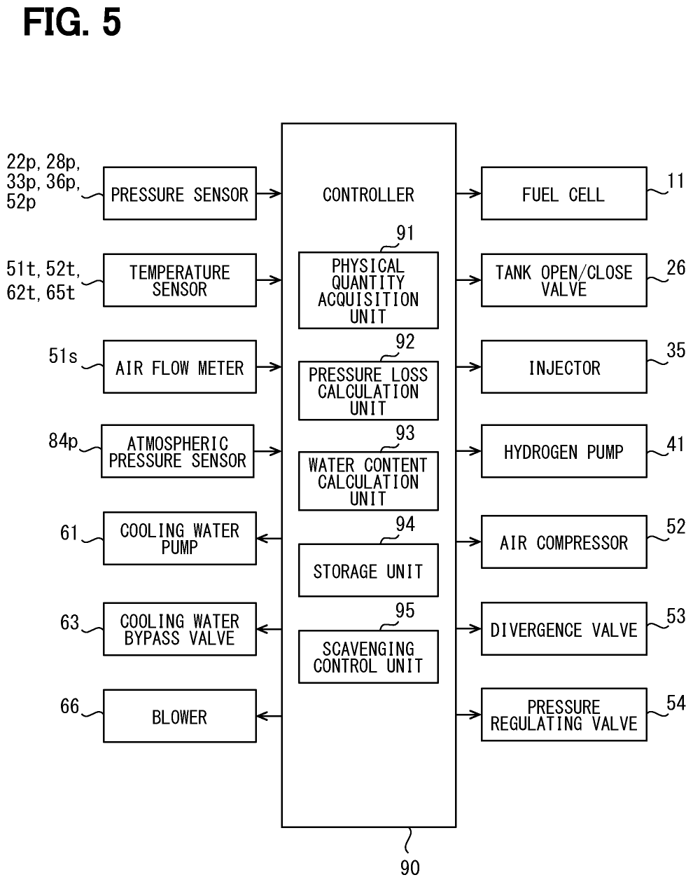

FIG. 5 is a figure depicting a control system. A control unit (ECU) in this specification is also called an electronic control unit (Electronic Control Unit) in some cases. The control unit is provided by (a) an algorithm as a plurality of pieces of logic called an if-then-else format or by (b) an algorithm as a learned model, for example a neural network, tuned by machine learning.

The control unit is provided by a control system including at least one computer. The control system includes a plurality of computers linked by a data communication apparatus in some cases. The computer includes at least one hardware processor which is a hardware-type processor. The hardware processor can be provided by the following (i), (ii) or (iii).

(i) The hardware processor is at least one processor core that executes a program stored on at least one memory in some cases. In this case, the computer is provided by the at least one memory, and the at least one processor core. The processor core is called a CPU: Central Processing Unit, a GPU: Graphics Processing Unit, an RISC-CPU or the like. The memory is also called a storage medium. The memory is a non-transitional, tangible storage medium that non-transitorily stores processor-readable “programs and/or data.” The storage medium is provided by a semiconductor memory, a magnetic disk, an optical disk or the like. The programs are distributed singly or as a storage medium having the programs stored thereon, in some cases.

(ii) The hardware processor is a hardware logic circuit in some cases. In this case, the computer is provided by a digital circuit including a large number of programmed logical units (gate circuits). The digital circuit is also called a logic circuit array, for example an ASIC: Application-Specific Integrated Circuit, an FPGA: Field Programmable Gate Array, a PGA: Programmable Gate Array, a CPLD: Complex Programmable Logic Device or the like. The digital circuit includes a memory having stored thereon programs and/or data in some cases. The computer is provided by an analog circuit in some cases. The computer is provided by a combination of a digital circuit and an analog circuit in some cases.

(iii) The hardware processor is a combination of (i) described above and (ii) described above in some cases. (i) and (ii) are arranged on different chips or on a common chip. In these cases, the portion of (ii) is also called an accelerator.

The control unit, a signal source, and a control target object provide various elements. At least some of these elements can be called blocks, modules or sections. Furthermore, elements included in the control system are called functional means only when the elements are intentional.

A controller and its technique described in this disclosure may be realized by a dedicated computer provided by configuring a processor and memory programmed to execute one or more functionalities embodied by a computer program. Alternatively, the controller and its technique described in this disclosure may be realized by a dedicated computer provided by configuring a processor by one or more dedicated hardware logic circuits. Alternatively, the controller and its technique described in this disclosure may be realized by one or more dedicated computers configured by a combination of a processor and memory programmed to execute one or more functionalities, and a processor configured by one or more hardware logic circuits. The computer program may be stored on a computer-readable, non-transitional tangible recording medium as instructions to be executed by a computer.

In FIG. 5, a controller 90 is connected with the pressure sensors 22p, 28p, 33p, 36p, and 52p, and the temperature sensors 51t, 52t, 62t, and 65t. The controller 90 acquires a filling side pressure measured by the filling side pressure sensor 22p. The controller 90 acquires a high-pressure supply side pressure measured by the high-pressure sensor 28p. The controller 90 acquires an intermediate-pressure supply side pressure measured by the intermediate-pressure sensor 33p. The controller 90 acquires a low-pressure supply side pressure measured by the low-pressure sensor 36p. The controller 90 acquires the pressure of air after being compressed measured by the air pressure sensor 52p. The controller 90 acquires an intake air temperature measured by the intake-air-temperature sensor 51t. The controller 90 acquires the temperature of air after being compressed measured by the supply air temperature sensor 52t. The controller 90 acquires the temperature of cooling water immediately after flowing out of the fuel cell 11 measured by the high-temperature sensor 62t. The controller 90 acquires the temperature of the cooling water immediately after flowing out of the radiator 64 measured by the low-temperature sensor 65t.

The controller 90 is connected with the air flow meter 51s, and an atmospheric pressure sensor 84p. The controller 90 acquires the flow rate of intake air measured by the air flow meter 51s. The controller 90 acquires an atmospheric pressure measured by the atmospheric pressure sensor 84p.

The controller 90 is connected with the cooling water pump 61, the cooling water bypass valve 63, and the blower 66. The controller 90 controls the cooling water pump 61 to control the amount of the cooling water flowing through the cooling flow path 69. The controller 90 controls the degree of opening of the cooling water bypass valve 63 to control the amount of the cooling water flowing through the cooling water bypass flow path 69i. The controller 90 controls the blower 66 to control the amount of air to flow through the radiator 64.

The controller 90 is connected with the fuel cell 11, the tank open/close valves 26, the injector 35, and the hydrogen pump 41. The controller 90 controls the fuel cell 11 to control the power generation amount, and the heat generation amount. The controller 90 controls the degrees of opening of the tank open/close valves 26 to control the amount of hydrogen to be supplied to the fuel cell 11. The controller 90 controls the injector 35 to control the amount of hydrogen to be supplied to the fuel cell 11. The controller 90 controls the hydrogen pump 41 to control the amount of hydrogen to circulate through the hydrogen circulation flow path 49.

The controller 90 is connected with the air compressor 52, the divergence valve 53, and the pressure regulating valve 54. The controller 90 controls the air compressor 52 to control the amount of air to be supplied to the fuel cell 11. The controller 90 controls the divergence valve 53 to control the amount of air to be supplied to the fuel cell 11. The controller 90 controls the pressure regulating valve 54 to control the amount of air to be supplied to the fuel cell 11.

The controller 90 performs control necessary for estimation of the water content, and control necessary for execution of the scavenging mode. The controller 90 includes a physical quantity acquisition unit 91, a pressure loss calculation unit 92, a water content calculation unit 93, a storage unit 94, and a scavenging control unit 95. The controller 90 can execute the water content estimation mode of estimating the water content of the fuel cell 11 by using the physical quantity acquisition unit 91, the pressure loss calculation unit 92, the water content calculation unit 93, and the storage unit 94. The physical quantity acquisition unit 91 acquires various physical quantities necessary for estimation of the water content. The pressure loss calculation unit 92 calculates a pressure loss in the flow path of air including the fuel cell 11 from physical quantities such as an air pressure acquired by the physical quantity acquisition unit 91. The water content calculation unit 93 calculates the water content in the flow path of air including the fuel cell 11 from physical quantities such as a pressure loss or a flow rate of air in the flow path of air including the fuel cell 11. The storage unit 94 stores a calculation formula to be used for calculations by the pressure loss calculation unit 92. The storage unit 94 stores a map M to be used for calculations by the water content calculation unit 93. The scavenging control unit 95 controls the air compressor 52 in the scavenging mode to control the amount of air to be fed to the fuel cell 11.

The water content estimation mode, and the scavenging mode, which are the control contents of the fuel cell system 1, are explained below. The water content estimation mode is a mode for estimating the water content in the flow path of air including the fuel cell 11. The fuel cell system 1 performs control of increasing the water content, control of lowering the water content, and the like in accordance with the estimated water content. While the fuel cell system 1 is being driven, the water content estimation mode is executed repeatedly to keep estimating the latest water content. It should be noted that the water content may be acquired on the basis of the impedance in case where the fuel cell 11 is generating power, the water content estimation mode may be executed in case where the fuel cell 11 is not generating power or in case where the power generation amount of the fuel cell 11 is very small, and so on. Even in case where the fuel cell system 1 is not being driven, the water content estimation mode may be executed when the fuel cell system 1 is monitored automatically on the basis of conditions such as that the outside air temperature is low.

Before the water content estimation mode is executed, it is preferred to check whether or not there is an abnormality of various types of sensors such as the air flow meter 51s, the supply air temperature sensor 52t or the air pressure sensor 52p. If there is an abnormality of the various types of sensors, it is likely that the water content cannot be estimated accurately. Because of this, it is preferred to notify a user of the fact that an abnormality of the various types of sensors has occurred, without executing the water content estimation mode.

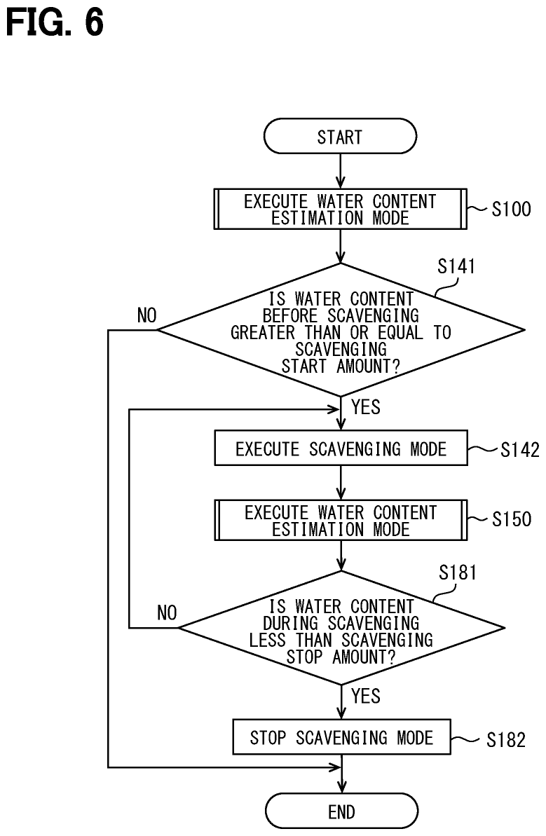

In FIG. 6, when the fuel cell system 1 starts being driven, at Step S100, the water content estimation mode is executed. It should be noted that situations where the fuel cell system 1 is driven include a situation where a user has turned on a switch such as an ignition switch, a situation where the fuel cell system 1 has started being driven automatically, and the like. Automatic starts of driving of the fuel cell system 1 include monitoring driving for preventing freezing, and scavenging driving for preventing freezing. Due to this automatic driving, it is possible to automatically hinder undesirable freezing of water around the fuel cell units 10 even in case where the outside air temperature is low.

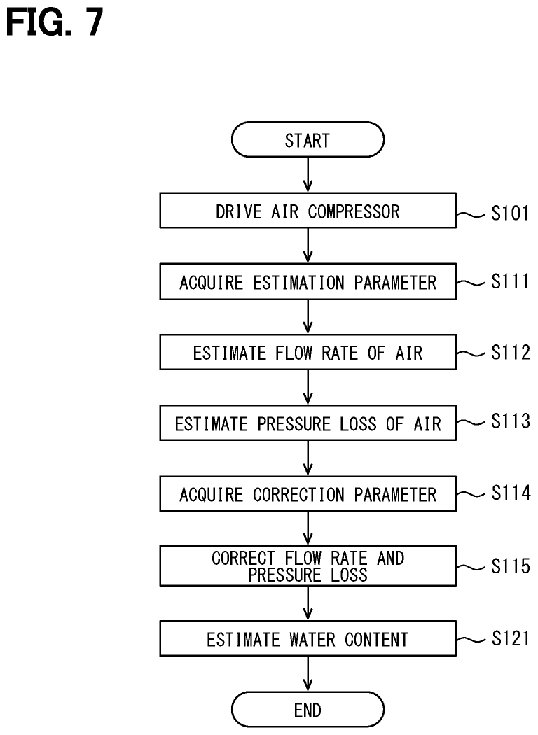

Specific contents of the water content estimation mode are explained below. In FIG. 7, at Step S101, the air compressor 52 is driven. Thereby, the fuel cell 11 is being supplied with compressed air. At this time, the amount of air supply to the fuel cell 11 is preferably at least greater than or equal to the amount of hydrogen supply to the fuel cell 11. The amount of air supply to the fuel cell 11 is preferably greater than a supply amount of air necessary for the fuel cell 11. After the air compressor 52 is driven, the process proceeds to Step S111.

At Step S111, estimation parameters are acquired. The estimation parameters are parameters used for estimation of the flow rate of air, and pressure loss of air in the flow path of air including the fuel cell 11. For example, the estimation parameters include physical quantities such as the flow rate of air measured by the air flow meter 51s, the temperature of air after being compressed measured by the supply air temperature sensor 52t or the pressure of air after being compressed measured by the air pressure sensor 52p. For example, the estimation parameters include information about the state of apparatuses and components such as the rotation speed of the air compressor 52. After the estimation parameters are acquired, the process proceeds to Step S112.

At Step S112, the flow rate of air flowing through the fuel cell 11 is estimated. The flow rate of air flowing through the fuel cell 11 is deemed to be equivalent to the flow rate measured by the air flow meter 51s. In case where the flow rate measured by the air flow meter 51s is a normal flow rate measured on the assumption of a reference state of 0° C. and 1 atm, it is necessary to convert the flow rate into an actual flow rate which is a flow rate of actually flowing air, by using the value of the atmospheric pressure, and the value of the air pressure measured by the air pressure sensor 52p. The conversion from the normal flow rate to the actual flow rate can be performed by a calculation of multiplying the normal flow rate by a ratio of the atmospheric pressure to the air pressure measured by the air pressure sensor 52p. Specifically, in case where the air compressor 52 has compressed the air to a pressure which is twice as high as the atmospheric pressure, the actual flow rate is half the normal flow rate. The flow rate of air provides an example of an oxidation gas flow rate.

It is also possible to estimate the flow rate of air without measuring the flow rate by the air flow meter 51s, by using a compression characteristics diagram which is a characteristics diagram representing a relationship among three parameters, the rotation speed, the compression ratio, and the flow rate, that are determined from the specifications of the air compressor 52. In this case, the flow rate of air can be estimated from the compression characteristics diagram by acquiring information about the rotation speed of the air compressor 52, and the compression ratio between air before and after the compression by the air compressor 52. After the flow rate of air is estimated, the process proceeds to Step S113.

At Step S113, a pressure loss of air flowing through the fuel cell 11 is estimated. The pressure loss of air in the flow path of air including the fuel cell 11 can be estimated by subtracting a pressure of air immediately after flowing out of the fuel cell 11 from a pressure of air immediately before flowing into the fuel cell 11. The pressure measured by the air pressure sensor 52p can be used as the pressure of air immediately before flowing into the fuel cell 11. The atmospheric pressure measured by the atmospheric pressure sensor 84p can be used as the pressure of air immediately after flowing out of the fuel cell 11. Accordingly, the pressure loss of air in the flow path of air including the fuel cell 11 can be estimated by subtracting the atmospheric pressure from the pressure measured by the air pressure sensor 52p. It should be noted that a predetermined value may be preset as the atmospheric pressure in case where the atmospheric pressure sensor 84p is not included. The pressure loss of air provides an example of an oxidation gas pressure loss. After the pressure loss of air is estimated, the process proceeds to Step S114.

At Step S114, correction parameters are acquired. The correction parameters are parameters used for correcting the estimated flow rate of air, and pressure loss of air of the fuel cell 11 to more accurate values. For example, the correction parameters include information about the degrees of opening of the divergence valve 53, and pressure regulating valve 54. For example, the correction parameters include information about the temperature of air after being compressed measured by the supply air temperature sensor 52t. After the correction parameters are acquired, the process proceeds to Step S115.

At Step S115, the flow rate of air estimated at Step S112, and the pressure loss of air estimated at Step S113 are corrected. In case where the divergence valve 53 is causing air to flow separately to both flow paths of the upstream side flow path 59u, and air bypass flow path 59i, the estimated flow rate of air is corrected on the basis of the degree of opening of the divergence valve 53. More specifically, correction is performed such that the estimated flow rate of air decreases as the degree of opening on the side of the air bypass flow path 59i increases. That is, the flow rate of air flowing to the fuel cell 11 is corrected by subtracting the flow rate of air having passed through the air bypass flow path 59i from the discharge amount of the air compressor 52. The same applies also to the pressure loss of air, the estimated pressure loss of air is corrected on the basis of the degree of opening of the divergence valve 53.

The pressure loss of air is corrected on the basis of the degree of opening of the pressure regulating valve 54. More specifically, the pressure loss at the pressure regulating valve 54 increases as the degree of opening of the pressure regulating valve 54 decreases. Because of this, correction is performed such that the estimated pressure loss of air of the fuel cell 11 decreases as the degree of opening of the pressure regulating valve 54 decreases. Even if the degree of opening of the pressure regulating valve 54 is the maximum degree, the pressure loss of air of the fuel cell 11 is preferably corrected taking into consideration the pressure loss at the pressure regulating valve 54 in case where there is a pressure loss due to passage of air through the pressure regulating valve 54.

The flow rate of air is corrected on the basis of the air temperature measured by the supply air temperature sensor 52t. In other words, the normal flow rate measured on the assumption of 0° C. is converted into an actual flow rate by correcting the normal flow rate to a flow rate at the actual air temperature. Supposing that the air temperature measured by the supply air temperature sensor 52t is Tα° C., the conversion from the normal flow rate to the actual flow rate can be performed by a calculation of multiplying the normal flow rate by (273+Tα)/273. For example, when the air temperature is 27.3° C., the actual flow rate is determined as a value obtained by multiplying the normal flow rate by 1.1. After the estimated values of the flow rate of air, and pressure loss of air are corrected, the process proceeds to Step S121.

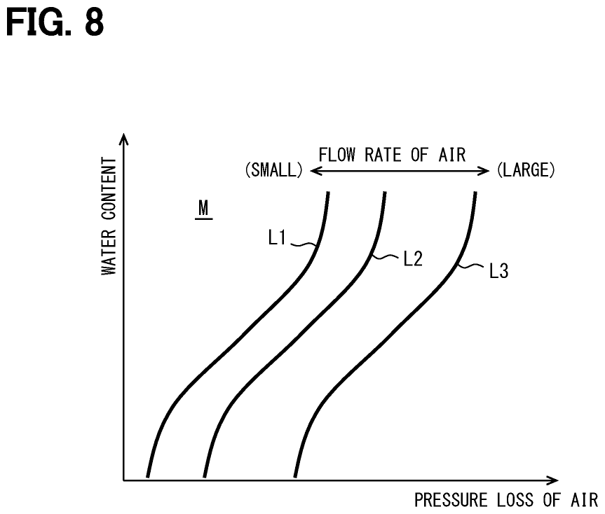

At Step S121, the water content is estimated. The water content is estimated from the flow rate of air, and pressure loss of air after being corrected. Estimation of the water content uses the map M depicted in FIG. 8. The map M is prestored in the storage unit 94, and represents a correlation among the flow rate of air, the pressure loss of air, and the water content. The map M has a plurality of characteristics lines L1, L2, and L3 stored therein. The characteristics lines L1, L2, and L3 have mutually approximately equal shapes. All the characteristics lines L1, L2, and L3 represent the tendency that the water content increases as the pressure loss increases.

A characteristics line in the plurality of characteristics lines to be used for estimation of the water content is determined in accordance with the flow rate of air. In case where the flow rate of air is small, the characteristics line L1 is used, and the water content is estimated from the pressure loss of air. On the other hand, in case where the flow rate of air is large, the characteristics line L3 is used, and the water content is estimated from the pressure loss of air. Even if the water content is the same, the pressure loss of air increases as the flow rate of air increases.

In estimation of the water content, a characteristics line in the plurality of characteristics lines L1, L2, and L3 that corresponds to a value which is the closest to the estimated flow rate of air is selected. Characteristics lines corresponding to flow rates of air which are other than the characteristics lines L1, L2, and L3 may be stored. The larger the number of stored characteristics lines is, the more finely a characteristics line corresponding to a value close to the current flow rate of air can be selected; accordingly, the precision of estimation of the water content can be enhanced. The water content can be estimated by selecting a characteristics line on the basis of the flow rate of air, and reading the water content on the basis of the pressure loss of air. It should be noted that methods of estimating the water content are not limited to the method mentioned above that uses the map M. For example, instead of using the map M, the water content may be estimated by using a calculation formula. After the water content is estimated, the water content estimation mode is ended, and the process proceeds to Step S141.

At Step S141 in FIG. 6, it is determined whether or not the water content before scavenging is greater than or equal to a scavenging start amount. The water content before scavenging is the water content of the flow path of air including the fuel cell 11 measured in a state before the scavenging mode is executed. In case where the water content before scavenging is greater than or equal to the scavenging start amount, it is decided that scavenging is necessary, and the process proceeds to Step S142. On the other hand, in case where the water content before scavenging is less than the scavenging start amount, it is decided that scavenging is not necessary, and estimation of the water content, and control related to scavenging are ended. If the fuel cell 11 is generating power, the power generation is continued. If the fuel cell 11 is not generating power, the air compressor 52 being driven for estimation of the water content is stopped. It should be noted that in case where it is likely the water content changes due to condensed water or in other similar cases, the air compressor 52 may not be stopped, but the water content may be kept being estimated.

At Step S142, the scavenging mode is executed. The scavenging mode is a mode of lowering the water content by feeding air to the fuel cell 11. In the scavenging mode, the driving state of the air compressor 52 which has been kept being driven for estimation of the water content is maintained. It should be noted that the output power of the air compressor 52 may be changed. For example, the air compressor 52 may be driven at a rotation speed higher than the rotation speed of the air compressor 52 in the water content estimation mode, and so on. The degrees of opening of the divergence valve 53, and pressure regulating valve 54 may be changed. For example, the divergence valve 53 is controlled to make the degree of opening on the side of the air bypass flow path 59i zero, and also the degree of opening of the pressure regulating valve 54 is maximized. Thereby, it becomes easier to ensure that the amount of air flowing to the fuel cell 11 is large. After the scavenging mode is executed, the process proceeds to Step S150.

At Step S150, the water content estimation mode is executed. Control contents in the water content estimation mode are similar to the control contents of Step S100. It should be noted that not the water content before scavenging, but the water content during scavenging is estimated. The water content during scavenging is the water content of the flow path of air including the fuel cell 11 measured during execution of the scavenging mode. Because of this, the water content that keeps lowering as the scavenging proceeds is estimated. After the water content estimation mode is executed, the process proceeds to Step S181.

At Step S181, it is determined whether or not the water content during scavenging is less than a scavenging stop amount. The scavenging stop amount is a water content set to an amount smaller than the scavenging start amount. In case where the water content during scavenging is less than the scavenging stop amount, it is decided that further scavenging is not necessary, and the process proceeds to Step S182. On the other hand, in case where the water content during scavenging is greater than or equal to the scavenging stop amount, it is decided that further scavenging is necessary, the process returns to Step S142, and the scavenging mode is continued.

At Step S182, the scavenging mode is stopped. In case where it is not necessary to drive the air compressor 52 like in case where there are no power generation requests, the air compressor 52 is stopped, and the series of control is ended. Alternatively, in case where it is necessary to drive the air compressor 52 like in case where there is a power generation request, the air compressor 52 continues being driven such that an amount of air necessary for power generation is supplied. After the scavenging mode is stopped, estimation of the water content, and control related to the scavenging are ended.

According to the embodiment mentioned above, the fuel cell system 1 includes the water content calculation unit 93 that calculates the water content in the flow path of air including the fuel cell 11 on the basis of the flow rate of air, and the pressure loss of air. Because of this, the water content of the fuel cell 11 can be estimated from physical quantities other than the impedance. Accordingly, even at the time of non-power generation when hydrogen is not being supplied, and at the time of micro power generation when the supply amount of hydrogen is small, the water content of the flow path of air including the fuel cell 11 can be estimated. In other words, the water content of the flow path of air including the fuel cell 11 can be estimated independently of the supply of hydrogen, which is a fuel gas.

The fuel cell system 1 includes the scavenging control unit 95 that controls the air compressor 52 on the basis of the estimated water content in the scavenging mode. Because of this, it is possible to provide the fuel cell system 1 that is capable of scavenging by estimating the water content independently of whether or not power generation is being performed. Accordingly, while the water content of the fuel cell 11 at the time of non-power generation is being estimated, the timing at which the scavenging mode is stopped can be decided rightly. Therefore, it is easier to hinder the fuel cell 11 from being not dry by stopping the scavenging mode before the fuel cell 11 becomes dry. Alternatively, it is easier to hinder unnecessary consumption of energy at the air compressor 52 due to continued execution of the scavenging mode even after the fuel cell 11 has become dry. In particular, in a situation where sounds other than the driving sound of the air compressor 52 are not generated like in case where the scavenging mode is executed as dry running after the fuel cell 11 stops being driven or during a soak, the driving sound of the air compressor 52 is noticed easily. Because of this, it is very important to optimize the execution time of the scavenging mode in the dry running, and execute scavenging mode without excess or deficiency.

The controller 90 estimates the water content before scavenging which is the water content before execution of the scavenging mode, and the water content during scavenging which is the water content during execution of the scavenging mode. Because of this, the scavenging mode can be controlled on the basis of the water content during scavenging. In other words, the scavenging mode can be controlled on the basis of the water content having changed due to the execution of the scavenging mode. Accordingly, it is easier to appropriately control the scavenging mode as compared with a case that the scavenging mode is controlled in accordance with the water content before scavenging without estimating the water content during scavenging.

The scavenging control unit 95 starts the scavenging mode in case where the water content before scavenging is greater than or equal to the scavenging start amount, and stops the scavenging mode in case where the water content during scavenging is less than the scavenging stop amount which is set to an amount smaller than the scavenging start amount. In other words, the scavenging control unit 95 starts the scavenging mode in case where the water content before scavenging is greater than or equal to the scavenging start amount, and continues the scavenging mode until the water content during scavenging becomes less than the scavenging stop amount which is set to an amount smaller than the scavenging start amount. Because of this, the end timing of the scavenging mode can be decided on the basis of the water content having changed due to the execution of the scavenging mode. Accordingly, it is easier to prevent the scavenging mode from being continued unnecessarily. Alternatively, it is easier to prevent the scavenging mode from being ended before the fuel cell 11 becomes dry for the reason that the execution time of the scavenging mode is too short. Therefore, the execution time of the scavenging mode can be optimized.

The controller 90 estimates the water content at the time of non-power generation when the fuel cell 11 has stopped power generation. In other words, the water content is estimated while the state where the fuel cell 11 has stopped is maintained. Because of this, unlike a case that the water content is estimated from the impedance in the fuel cell 11, it is not necessary to drive the fuel cell 11, and to start power generation for the purpose of estimating the water content. Accordingly, the state where the power generation of the fuel cell 11 has stopped can be maintained longer. Furthermore, in any case, there cannot be an increase of water newly generated due to power generation at the time of estimation of the water content. Because of this, it is possible to hinder extension of execution time of the scavenging mode that is necessitated by an increase of water that should be removed by scavenging.

The controller 90 estimates the water content during a soak when the fuel cell 11 has stopped being driven. Because of this, the water content of the fuel cell 11 can be estimated precisely as compared with a case that the water content during a soak is estimated from the water content before the soak of the fuel cell 11, elapsed time, and the like. Accordingly, even in case where the water content has increased independently of power generation due to condensed water generated during the soak or the like, it is possible to grasp an increase of the water content, and take measures for lowering the water content.

According to the embodiment mentioned above, the controller 90 includes the water content calculation unit 93 that calculates the water content in the flow path of air including the fuel cell 11 on the basis of the flow rate of air, and the pressure loss of air. Because of this, the water content in the flow path of air including the fuel cell 11 can be estimated from physical quantities other than the impedance. Accordingly, even at the time of non-power generation when hydrogen is not being supplied, and at the time of micro power generation when the supply amount of hydrogen is small, the water content of the flow path of air including the fuel cell 11 can be estimated. In other words, it is possible to provide the fuel cell system 1 that can estimate the water content of the flow path of air including the fuel cell 11 independently of the supply of hydrogen, which is a fuel gas.

Because the water content can be estimated independently of the supply of hydrogen, the water content can be estimated while the tank open/close valves 26 are kept being closed. Accordingly, it is easier to keep the consumption amount of hydrogen, which is a fuel, low. Because the water content can be estimated independently of power generation of the fuel cell 11, it is not necessary to cause the fuel cell 11 to generate power for the purpose of estimating the water content. Accordingly, it is easier to generate power efficiently by reducing the fuel consumption of the fuel cell system 1. Furthermore, it is easier to freely set the timing of estimation of the water content. For example, the water content can be estimated even during a so-called soak that starts when the fuel cell system 1 has stopped being driven and lasts until the fuel cell system 1 starts being driven again. Alternatively, the water content in a state immediately before the fuel cell 11 stops power generation can be estimated. Accordingly, it is easier to control scavenging while power generation by the fuel cell 11 has stopped power generation, on the basis of an appropriate water content.

The controller 90 corrects the flow rate of air on the basis of the degree of opening of the divergence valve 53 in the water content estimation mode. Because of this, the flow rate of air flowing to the fuel cell 11 can be estimated precisely even in case where air is partially flowing to the air bypass flow path 59i.

The pressure loss calculation unit 92 calculates the pressure loss of air from the difference between the air pressure measured by the air pressure sensor 52p and the atmospheric pressure measured by the atmospheric pressure sensor 84p in the water content estimation mode. Because of this, the pressure loss of air can be estimated precisely as compared with a case that a predetermined value set in advance is treated as the atmospheric pressure. In particular, in case where the fuel cell system 1 is driven at a highland or a lowland, the actual value of the atmospheric pressure easily differs from the preset predetermined value. Because of this, it is important to measure the actual atmospheric pressure by the atmospheric pressure sensor 84p in case where the ambient atmospheric pressure of the fuel cell system 1 changes easily like in case where the fuel cell system 1 is mounted on a vehicle.

The controller 90 corrects the flow rate of air by using the temperature of air measured by the supply air temperature sensor 52t in the water content estimation mode. Because of this, the flow rate of air can be estimated precisely as compared with a case that the flow rate of air is calculated ignoring temperature changes of the air.

After the water content is estimated by using the map M at Step S121, the water content may be corrected on the basis of the temperature of the fuel cell 11. As the temperature of the fuel cell 11 increases, the inter-cell air flow paths 112 increase in size more significantly due to thermal expansion, and the flow path area increases. Because of this, the pressure loss of air of the inter-cell air flow paths 112 decreases more easily. In other words, a high temperature of the fuel cell 11 makes it likely that the water content is estimated as being smaller than the actual water content. Accordingly, by performing correction such that the water content is determined as being larger as the temperature of the fuel cell 11 increases, it is possible to correct an error of the water content that results from a thermal expansion of the inter-cell air flow paths 112. Thereby, it is easier to enhance the precision of estimation of the water content.

The controller 90 estimates the water content by using the map M. Because of this, it is easier to estimate the water content simply as compared with a case that the water content is estimated by using a complicated calculation formula instead of the map M. Accordingly, it is easier to obtain results of estimation of the water content in a short time. Therefore, it is easier to obtain a value close to the current water content as an estimated value of the water content.

### Second Embodiment

This embodiment is a modification example whose basic form is the preceding embodiment. In this embodiment, a plurality of scavenging modes including weak and strong scavenging modes with different output power are used in a switching manner.

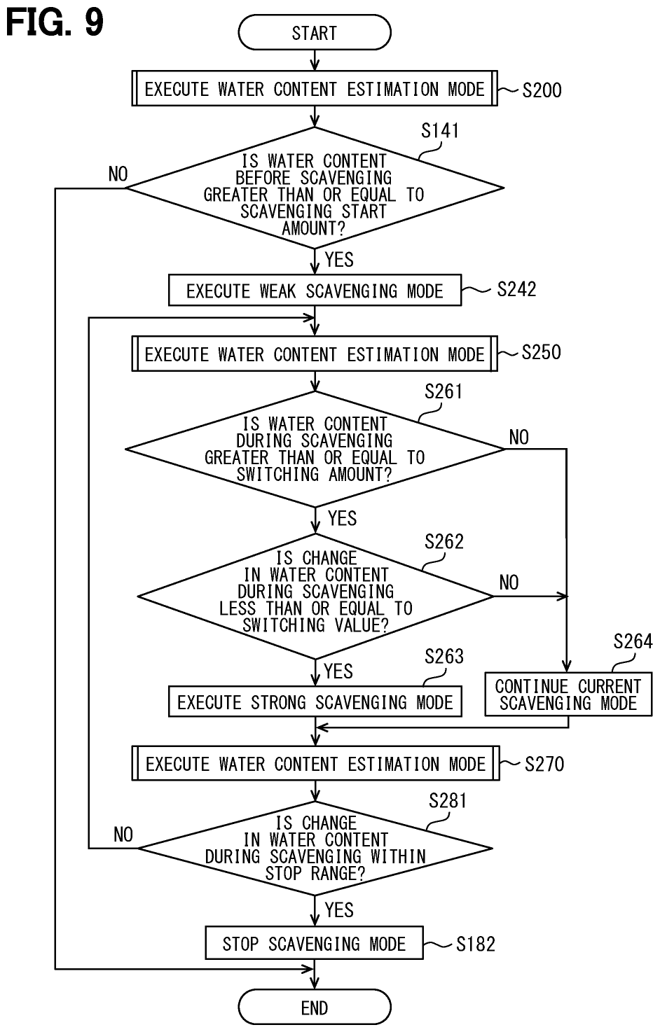

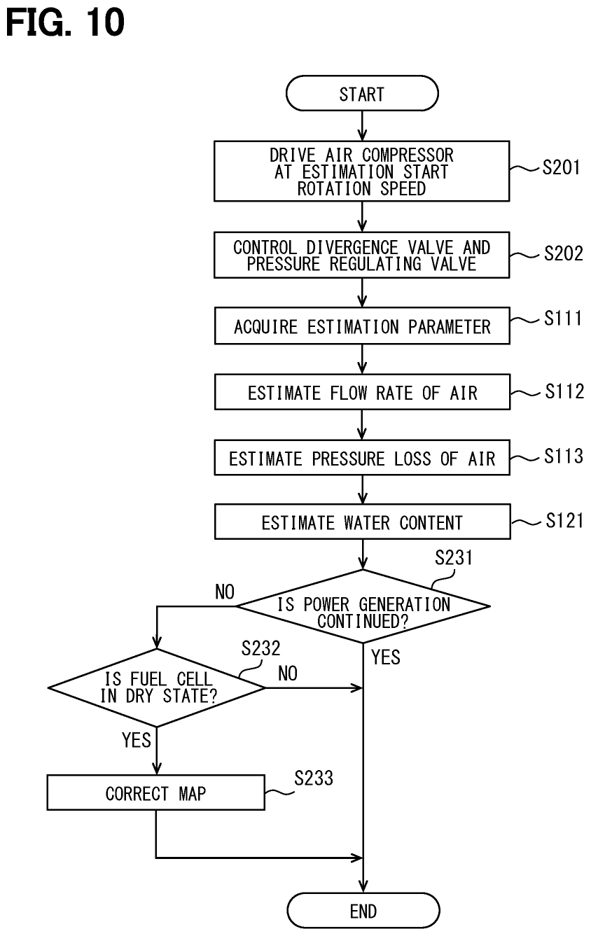

In FIG. 9, when the fuel cell system 1 starts being driven, at Step S200, the water content estimation mode is executed. Specific contents of the water content estimation mode are explained below. In FIG. 10, at Step S201, the air compressor 52 is driven at an estimation start rotation speed. The estimation start rotation speed is a rotation speed at which a pressure measured by the air pressure sensor 52p becomes a pressure sufficiently higher than the atmospheric pressure. By driving the air compressor 52 at the estimation start rotation speed, the supply amount of air becomes an estimation start supply amount set to an amount greater than a supply amount of air necessary for power generation by the fuel cell 11. In other words, by driving the air compressor 52 at the estimation start rotation speed, an amount of air by which a change in the water content in the flow path of air including the fuel cell 11 becomes detectable as a pressure loss of air is supplied. Thereby, the fuel cell 11 is being supplied with compressed air sufficiently. In case where the air compressor 52 is rotation-driven at the estimation start rotation speed, the amount of air supply to the fuel cell 11 becomes greater than the amount of hydrogen supply to the fuel cell 11.

Instead of maintaining the rotation speed of the air compressor 52 at the estimation start rotation speed, the rotation speed may be varied within a range greater than or equal to the estimation start rotation speed. Alternatively, in case where the air compressor 52 includes a plurality of air compressors, the supply amount of air may be increased by increasing the number of air compressors to be driven. After the air compressor 52 is driven, the process proceeds to Step S202.

At Step S202, the divergence valve 53, and the pressure regulating valve 54 are controlled. Specifically, by controlling the degree of opening of the divergence valve 53, air is prevented from flowing to the air bypass flow path 59i. In addition to this, by fully opening the pressure regulating valve 54, the pressure loss generated to air flowing through the downstream side flow path 59d due to the pressure regulating valve 54 is minimized. As a result of these processes, the pressure loss that occurs at portions other than the fuel cell 11 in the flow of air becomes sufficiently small as compared with the pressure loss that occurs at the fuel cell 11. After the divergence valve 53, and the pressure regulating valve 54 are controlled, the process proceeds to Step S111.

After the estimation parameters are acquired at Step S111, the process proceeds to Step S112. After the flow rate of air is estimated at Step S112, the process proceeds to Step S113. After the pressure loss of air is estimated at Step S113, the process proceeds to Step S121. After the water content is estimated at Step S121, the process proceeds to Step S231.

At Step S231, it is determined whether or not power generation is being continued. In case where power generation in the fuel cell 11 is being continued, it is decided that water is being generated due to a chemical reaction between hydrogen and oxygen in the fuel cell 11, and the water content estimation mode is ended. On the other hand, in case where power generation in the fuel cell 11 is not being continued, it is decided that water is not newly generated in the fuel cell 11, the process proceeds to Step S232.

At Step S232, it is determined whether or not the fuel cell 11 is dry. In case where the fuel cell 11 is dry, the process proceeds to Step S233. On the other hand, in case where the fuel cell 11 is not dry, the water content estimation mode is ended.

An example of methods of determining whether or not the fuel cell 11 is dry is a method in which it is determined whether or not the flow rate of air is greater than or equal to a dry state flow rate. The dry state flow rate is a flow rate of air flowing through the dry fuel cell 11 having a water content which is approximately zero. In the dry fuel cell 11, there is almost no water that hinders the flow of air inside the fuel cell 11. Because of this, in case where the air compressor 52 is driven at the same output power, the flow rate of air becomes higher in the dry fuel cell 11 as compared with the wet fuel cell 11 having a large water content. In case where the flow rate of air is greater than or equal to the dry state flow rate, it is decided that there is almost no water that hinders the flow of air, and it can be determined that the fuel cell 11 is dry. On the other hand, in case where the flow rate of air is smaller than the dry state flow rate, it is decided that there is water that hinders the flow of air, and it can be determined that the fuel cell 11 is not dry.

An example of methods of determining whether or not the fuel cell 11 is dry is a method in which it is determined whether or not a change in the flow rate of air is less than or equal to a predetermined value in a state that the output power of the air compressor 52 is kept constant. If the fuel cell 11 is wet, water is removed by driving of the air compressor 52, and the flow rate of air increases gradually. On the other hand, if the fuel cell 11 is dry, there is no water to be removed, and the flow rate of air remains constant. Accordingly, a change in the flow rate of air is zero. Therefore, in case where a change in the flow rate of air is less than or equal to a predetermined value, it can be determined that the fuel cell 11 is dry.

An example of methods of determining whether or not the fuel cell 11 is dry is a method in which it is determined whether or not the pressure loss of air is smaller than a dry state pressure loss. The dry state pressure loss is a pressure loss that occurs in the dry fuel cell 11 having a water content which is approximately zero. In the dry fuel cell 11, there is almost no water that hinders the flow of air inside the fuel cell 11. Because of this, in case where the air compressor 52 is driven at the same output power, the pressure loss of air becomes smaller in the dry fuel cell 11 as compared with the wet fuel cell 11 having a large water content. In case where the pressure loss of air is smaller than the dry state pressure loss, it is decided that there is almost no water that hinders the flow of air, and it can be determined that the fuel cell 11 is dry. In case where the flow rate of air is greater than or equal to the dry state pressure loss, it is decided that there is water that hinders the flow of air, and it can be determined that the fuel cell 11 is not dry.

An example of methods of determining whether or not the fuel cell 11 is dry is a method in which it is determined whether or not a change in the pressure loss of air is less than or equal to a predetermined value in a state that the output power of the air compressor 52 is kept constant. If the fuel cell 11 is wet, water is removed by driving of the air compressor 52, and the pressure loss of air lowers gradually. On the other hand, if the fuel cell 11 is dry, there is no water to be removed, and the pressure loss of air remains constant. Accordingly, a change in the pressure loss of air is zero. Therefore, in case where a change in the pressure loss of air is less than or equal to a predetermined value, it can be determined that the fuel cell 11 is dry.

At Step S233, the map M is corrected on the basis of the flow rate of air, and pressure loss of air of the dry fuel cell 11. More specifically, the entire characteristics lines are translated such that the water content becomes the smallest with the values of the flow rate of air, and pressure loss of air of the dry fuel cell 11. At this time, instead of translating only one characteristics line, the plurality of characteristics lines are entirely translated preferably. Thereby, the entire map M can be corrected by performing correction once. After the water content is estimated, the water content estimation mode is ended, and the process proceeds to Step S141.

At Step S141 in FIG. 9, it is determined whether or not the water content before scavenging is greater than or equal to the scavenging start amount. In case where the water content before scavenging is greater than or equal to the scavenging start amount, it is decided that scavenging is necessary, and the process proceeds to Step S242. On the other hand, in case where the water content before scavenging is less than the scavenging start amount, it is decided that execution of scavenging is not necessary, and estimation of the water content, and control related to scavenging are ended.

At Step S242, the weak scavenging mode is executed. For example, the weak scavenging mode is a mode of driving the air compressor 52 at a rotation speed which is so low that driving sounds, and driving vibration of the air compressor 52 cannot be perceived by a user. It should be noted that the rotation speed of the air compressor 52 in the weak scavenging mode is not limited to the rotation speed mentioned above. After the weak scavenging mode is executed, the process proceeds to Step S250.

At Step S250, the water content estimation mode is executed. Control contents in the water content estimation mode are similar to the control contents of Step S200. It should be noted that instead of the water content before scavenging, the water content during scavenging which is a water content that lowers as the scavenging proceeds is estimated. After the water content estimation mode is executed, the process proceeds to Step S261.

At Step S261, it is determined whether or not the water content during scavenging is greater than or equal to a switching amount. The switching amount is a water content to serve as a reference amount for deciding whether or not it is necessary to switch the output power of the scavenging mode. The switching amount is set to an amount which is at least greater than or equal to the scavenging stop amount. In case where the water content during scavenging is greater than or equal to the switching amount, the process proceeds to Step S262. On the other hand, in case where the water content during scavenging is less than the switching amount, it is decided that it is not necessary to switch the output power of the scavenging mode, and the process proceeds to Step S264.

At Step S262, it is determined whether or not a change in the water content during scavenging is less than or equal to a switching value. A change in the water content during scavenging is a decrease of the water content during scavenging per unit time. In case where the water content during scavenging has increased as time elapses, a change in the water content during scavenging becomes a negative value. The switching value is a change in the water content which serves as a reference value for deciding whether or not it is necessary to switch the output power of the scavenging mode. The switching value is zero, for example. In case where the change in the water content during scavenging is less than or equal to the switching value, it is decided that the water content has not lowered in the current scavenging mode, and the process proceeds to Step S263. On the other hand, in case where the change in the water content during scavenging is greater than the switching value, it is decided that the water content has lowered in the current scavenging mode, and the process proceeds to Step S264.

At Step S263, the strong scavenging mode is executed. For example, the strong scavenging mode is a mode of driving the air compressor 52 at a rotation speed which is a specification upper limit rotation speed determined in accordance with the specifications of the air compressor 52. It should be noted that the rotation speed of the air compressor 52 in the strong scavenging mode is not limited to the rotation speed mentioned above, but it is sufficient if the air compressor 52 is driven at output power at least greater than the output power in the weak scavenging mode. For example, in case where the air compressor 52 includes two air compressors, only one air compressor may be driven in the weak scavenging mode, and the two air compressors may be driven in the strong scavenging mode, and so on. After the strong scavenging mode is executed, the process proceeds to Step S270.

At Step S264, the current scavenging mode is continued. That is, if the current scavenging mode is the weak scavenging mode, the weak scavenging mode is continued. If the current scavenging mode is the strong scavenging mode, the strong scavenging mode is continued. While the current scavenging mode is kept continued, the process proceeds to Step S270.

At Step S270, the water content estimation mode is executed. Control contents in the water content estimation mode are similar to the control contents of Step S200 and Step S250. Here, instead of the water content before scavenging, the water content during scavenging which is a water content that lowers as the scavenging proceeds is estimated. After the water content estimation mode is executed, the process proceeds to Step S281.

At Step S281, it is determined whether or not a change in the water content during scavenging is within a stop range. The stop range is a range of changes of the water content during scavenging from zero to a change set to an amount smaller than the switching value. In case where the change in the water content during scavenging is within the stop range, it can be decided that the change in the water content during scavenging due to execution of the scavenging mode is small. Accordingly, it is decided that there is almost no water to be removed by scavenging, further scavenging is not necessary, and the process proceeds to Step S182. At Step S182, the scavenging mode is stopped, and estimation of the water content, and control related to the scavenging are ended. On the other hand, in case where the change in the water content during scavenging is outside the stop range, it can be decided that the change in the water content during scavenging due to execution of the scavenging mode is large. Accordingly, it is decided that there is still water that should be removed by scavenging, and further scavenging is necessary, the process returns to Step S250, and the scavenging mode is continued.

According to the embodiment mentioned above, the scavenging control unit 95 starts the scavenging mode in case where the water content before scavenging is greater than or equal to the scavenging start amount, and stops the scavenging mode in case where a change in the water content during scavenging is within the stop range. Because of this, the end timing of the scavenging mode can be decided on the basis of the change in the water content that changes depending on the execution of the scavenging mode. Therefore, it is easier to prevent the scavenging mode from being continued unnecessarily. It is easier to prevent the scavenging mode from being ended before the fuel cell 11 becomes dry for the reason that the execution time of the scavenging mode is too short. As a result of these processes, the execution time of the scavenging mode can be optimized.

The controller 90 executes the strong scavenging mode of increasing the output power of the air compressor 52 in the scavenging mode in case where the water content during scavenging is greater than or equal to the switching amount, and a change in the water content during scavenging is less than or equal to the switching value. Because of this, it is easier to remove water smoothly as compared with a case that the weak scavenging mode is continued. It is easier to hinder the comfortability of a user from being impaired due to vibration and sounds that are generated by the air compressor 52, as compared with a case that the strong scavenging mode is executed from the beginning. In particular, in case where the fuel cell system 1 is mounted on a vehicle, the comfortability in the interior of the vehicle is impaired easily due to vibration and sounds that are transmitted to the interior of the vehicle. Because of this, in case where the fuel cell system 1 is mounted on a vehicle, it is very important to separately use the weak scavenging mode that provides higher comfortability for a user, and the strong scavenging mode that provides a higher water-removing capability.

The controller 90 controls the air compressor 52 such that the supply amount of air by the air compressor 52 becomes greater than or equal to the estimation start supply amount in the water content estimation mode. Because of this, it is easier to hinder the occurrence of situations where an estimated value of the water content differs significantly from the actual water content because the flow rate of air flowing through the fuel cell 11 is too small. Accordingly, the water content of the fuel cell 11 can be estimated stably, and precisely. In particular, in a state where the fuel cell 11 is not generating power or in a state where the power generation amount is very small, the supply amount of air necessary for power generation is small, and accordingly the precision of estimation of the water content lowers easily. However, by making the supply amount of air greater than or equal to the estimation start supply amount forcibly, it is easier to keep the precision of estimation of the water content high.

According to the embodiment mentioned above, the controller 90 controls the air compressor 52 such that the supply amount of air by the air compressor 52 becomes greater than or equal to the estimation start supply amount in the water content estimation mode. Because of this, it is easier to hinder the occurrence of situations where an estimated value of the water content differs significantly from the actual water content because the flow rate of air flowing through the fuel cell 11 is too small. Accordingly, the water content in the flow path of air including the fuel cell 11 can be estimated stably, and precisely. In particular, in a state where the fuel cell 11 is not generating power or in a state where the power generation amount is very small, the supply amount of air necessary for power generation is small, and accordingly the precision of estimation of the water content lowers easily. However, by making the supply amount of air greater than or equal to the estimation start supply amount forcibly, it is easier to keep the precision of estimation of the water content high.

In case where the water content estimation mode is executed, the controller 90 controls the air compressor 52 such that the amount of oxygen supply to the fuel cell 11 becomes larger than the amount of hydrogen supply to the fuel cell 11. Because of this, it is possible to ensure that there is an amount of oxygen necessary for power generation of the fuel cell 11, and also it is possible to ensure that there is a large flow rate of air flowing through the fuel cell 11, and perform estimation of the water content precisely.

In the water content estimation mode, the controller 90 controls the divergence valve 53 to maintain a state where air does not flow to the air bypass flow path 59i. Because of this, the flow rate of air flowing to the air bypass flow path 59i bypassing the fuel cell 11 can be made zero. Accordingly, the flow rate of air having flowed through the fuel cell 11 can be estimated without making a correction regarding an amount of air having flowed to the air bypass flow path 59i in accordance with the flow rate of air discharged from the air compressor 52. Therefore, it is easier to precisely estimate the flow rate of air having flowed through the fuel cell 11.

In the water content estimation mode, in case where the fuel cell 11 is not generating power, and the fuel cell 11 is dry, the controller 90 corrects the map M considering that the water content is the lowest in this state. Because of this, the map M can be optimized taking into consideration ageing, differences between models of the fuel cell system 1, and the like. Accordingly, it is easier to enhance the precision of estimation of the water content by estimating the water content by using the optimized map M.

In the water content estimation mode, the controller 90 controls the rotation speed of the air compressor 52 constantly at the estimation start rotation speed. This manner of control can produce a state where only changes in the water content influence changes in the flow rate, and changes in the pressure loss. Accordingly, it is easier to grasp changes in the water content from changes in the flow rate of air, and pressure changes. Therefore, it is easier to precisely estimate the water content as compared with a case that the water content is estimated while the rotation speed of the air compressor 52 is changed.

### Third Embodiment

This embodiment is a modification example whose basic form is the preceding embodiment. In this embodiment, it is determined whether or not there is an abnormality of water-clogging.

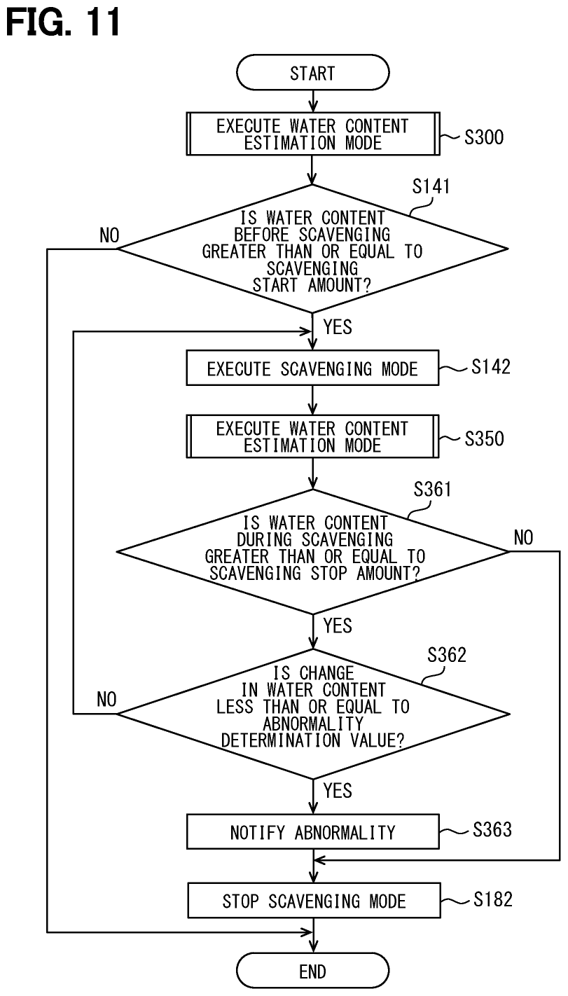

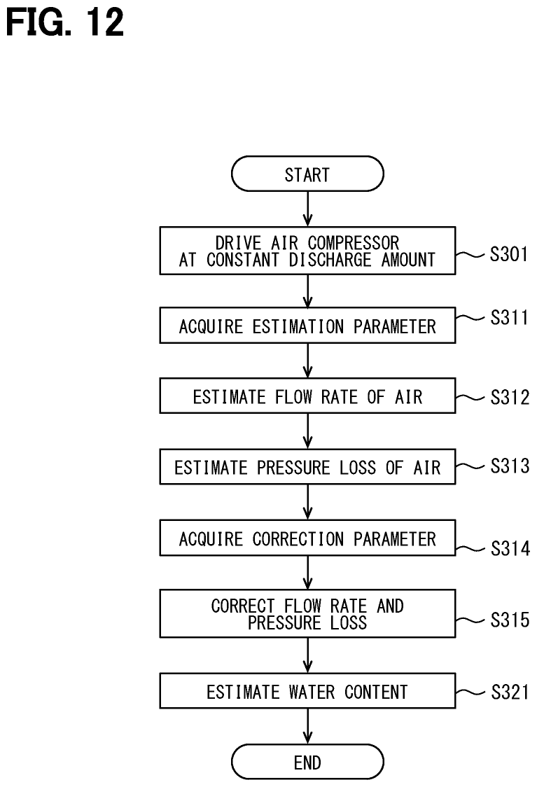

In FIG. 11, when the fuel cell system 1 starts being driven, at Step S300, the water content estimation mode is executed. Specific contents of the water content estimation mode are explained below. In FIG. 12, at Step S301, the air compressor 52 is driven such that the discharge amount of air discharged from the air compressor 52 remains constant. The flow rate of air changes depending on the water content. In other words, if the water content increases, the discharge amount decreases easily because it is difficult for air to flow to the flow path of air including the fuel cell 11. Accordingly, by increasing the rotation speed of the air compressor 52, a decrease of the flow rate of air is compensated for, and the discharge amount is kept constant. On the other hand, if the water content decreases, the discharge amount increases easily because it is easier for air to flow to the flow path of air including the fuel cell 11. Accordingly, by lowing the rotation speed of the air compressor 52, an increase of the discharge amount is cancelled out, and the flow rate of air is kept constant. After the air compressor 52 is driven while feedback control is executed such that the discharge amount remains constant in this manner, the process proceeds to Step S311.

At Step S311, an estimation parameter is acquired. Here, as the estimation parameter, the pressure of air after being compressed measured by the air pressure sensor 52p is acquired. After the pressure of the air after being compressed, which is an estimation parameter is acquired, the process proceeds to Step S312.

At Step S312, the flow rate of air flowing through the fuel cell 11 is estimated. The flow rate of air flowing through the fuel cell 11 is deemed to be equivalent to the discharge amount of the air compressor 52. After the flow rate of air flowing through the fuel cell 11 is estimated, the process proceeds to Step S313.

At Step S313, a pressure loss of air flowing through the fuel cell 11 is estimated. The pressure loss of the air in the flow path of air including the fuel cell 11 can be estimated by subtracting the atmospheric pressure measured by the atmospheric pressure sensor 84p from the pressure measured by the air pressure sensor 52p. After the pressure loss of air is estimated, the process proceeds to Step S314.

At Step S314, correction parameters are acquired. Here, for example, as the correction parameters, information about the degrees of opening of the divergence valve 53, and pressure regulating valve 54 is acquired. After the correction parameters are acquired, the process proceeds to Step S315.

At Step S315, the flow rate of air estimated at Step S312, and the pressure loss of air estimated at Step S313 are corrected. In case where the divergence valve 53 is causing air to flow separately to both flow paths of the upstream side flow path 59u, and air bypass flow path 59i, the estimated flow rate of air, and pressure loss of air are corrected on the basis of the degree of opening of the divergence valve 53. The pressure loss of air of the fuel cell 11 is corrected on the basis of the pressure loss due to the pressure regulating valve 54. In case where it is not necessary to correct the flow rate of air, the discharge amount of the air compressor 52 becomes the flow rate of air of the fuel cell 11 as is. After the estimated values of the flow rate of air, and pressure loss of air are corrected, the process proceeds to Step S321.

At Step S321, the water content is estimated. The water content is estimated from the flow rate of air after being corrected, and the pressure loss of air after being corrected. Estimation of the water content uses the map M depicted in FIG. 8. The map M is prestored in the storage unit 94, and represents a correlation among the flow rate of air, the pressure loss of air, and the water content. The map M has a plurality of characteristics lines L1, L2, and L3 stored therein, and the characteristics lines L1, L2, and L3 have mutually approximately equal shapes.

A characteristics line to be used for estimation of the water content is decided in accordance with the flow rate of air flowing through the fuel cell 11. In case where the flow rate of air is small, the characteristics line L1 is used, and the water content is estimated from the pressure loss of air. On the other hand, in case where the flow rate of air is large, the characteristics line L3 is used, and the water content is estimated from the pressure loss of air. Accordingly, by performing control such that the flow rate of air constantly matches a flow rate of any of the characteristics lines L1, L2, and L3 at Step S301, the water content can be estimated precisely. After the water content is estimated, the water content estimation mode is ended, and the process proceeds to Step S141.

At Step S141 in FIG. 11, it is determined whether or not the water content before scavenging is greater than or equal to the scavenging start amount. In case where the water content before scavenging is greater than or equal to the scavenging start amount, it is decided that scavenging is necessary, the process proceeds to Step S142, the scavenging mode is executed at Step S142, and then the process proceeds to Step S350. On the other hand, in case where the water content before scavenging is less than the scavenging start amount, it is decided that scavenging is not necessary, and estimation of the water content, and control related to scavenging are ended.

At Step S350, the water content estimation mode is executed. Control contents in the water content estimation mode are similar to the control contents of Step S300. It should be noted that instead of the water content before scavenging, the water content during scavenging which is a water content that lowers as the scavenging proceeds is estimated. After the water content estimation mode is executed, the process proceeds to Step S361.

At Step S361, it is determined whether or not the water content during scavenging is greater than or equal to a scavenging stop amount. If the water content during scavenging is greater than or equal to the scavenging stop amount, it is decided that scavenging has not been completed, and the process proceeds to Step S362. If the water content during scavenging is less than the scavenging stop amount, it is decided that scavenging has been completed, and the process proceeds to Step S182.

At Step S362, it is determined whether or not a change in the water content is less than or equal to an abnormality determination value. The abnormality determination value is a change in the water content which serves as a reference value for deciding whether or not an abnormality such as water-clogging has occurred in the fuel cell 11. The abnormality determination value is zero, for example. In case where the change in the water content is less than or equal to the abnormality determination value, it is decided that an abnormality such as water-clogging has occurred, and scavenging is not proceeding, and the process proceeds to Step S363. On the other hand, in case where the change in the water content is greater than the abnormality determination value, it is decided that scavenging is proceeding, the process returns to Step S142, and the scavenging mode is continued.

At Step S363, a user is notified of the occurrence of the abnormality. The user is notified not only of the occurrence of the abnormality such as water-clogging in the fuel cell 11, but preferably also of information as to whether it is or is not possible to generate power in the state where the abnormality has occurred, information about an approximate amount of power that can be generated, and the like. In case where the fuel cell system 1 is mounted on a mobile body such as a vehicle, it is preferred to notify a warning to stop the movement of the mobile body, and so on as necessary, along with the notification about the abnormality. In accordance with the type of the abnormality, it is preferred to notify a content that recommends replacement of a component, or a content to recommend execution of a mode for solving the abnormality. After the abnormality is notified, the process proceeds to Step S182.

At Step S182, the scavenging mode is stopped, and estimation of the water content, and control related to the scavenging are ended. If the abnormality is being notified, it is preferred to end estimation of the water content, and control related to the scavenging while the notification of the abnormality is kept continued.

According to the embodiment mentioned above, the controller 90 notifies the occurrence of an abnormality in case where the water content during scavenging is greater than or equal to the scavenging stop amount, and a change in the water content during scavenging is less than or equal to the abnormality determination value. Because of this, a user can recognize that an abnormality such as water-clogging has occurred in the fuel cell system 1. For example, in case where an abnormality such as water-clogging has occurred, the power generation efficiency of the fuel cell 11 is low. By allowing the user to recognize that an abnormality of water-clogging has occurred, the user can select either power generation with the fuel cell 11 still having lowered power generation efficiency or power generation with the fuel cell 11 whose abnormality of water-clogging has been solved. In particular, in case where water that has caused water-clogging is frozen to become ice, it is expected that the water-clogged state continues until the ice melts. In this case, the user can make a choice from various choices as to how to deal with the abnormality, such as melting the ice by generating heat by performing power generation with the fuel cell 11 or melting the ice by waiting for an increase of the outside air temperature. Accordingly, it is very important to notify the occurrence of an abnormality to a user for allowing the user to make an optimum choice as to how to deal with the abnormality having occurred.

According to the embodiment mentioned above, the controller 90 controls the air compressor 52 such that the discharge amount remains constant in the water content estimation mode. Because of this, in case where the discharge amount of the air compressor 52 can be deemed to be the flow rate of air of the fuel cell 11, the water content can be estimated by estimating only the pressure loss of the fuel cell 11. Accordingly, it is easier to promptly estimate the water content.

### Other Embodiments

In the air flow path 59, an air cooling apparatus such as an intercooler may be included between the air compressor 52 and the fuel cell 11. By providing the air cooling apparatus, it is possible to cause air having been compressed by the air compressor 52 to have an increased temperature to flow to the fuel cell 11 after being cooled. Because of this, it is easier to hinder a temperature increase of the fuel cell 11. Accordingly, it is easier to hinder the deterioration of the fuel cell 11, and to maintain the state where the power generation efficiency is high. In this case, the air pressure sensor 52p, and the supply air temperature sensor 52t are preferably provided downstream of the intercooler.

An ion exchanger may be included in the cooling water bypass flow path 69i. By providing the ion exchanger, it is possible to stably ensure that the cooling water for cooling the fuel cell 11 is kept insulated. Accordingly, it is easier to enhance the safety of the fuel cell system 1.

The disclosure in this specification, figures, and the like is not restricted to the embodiments that are depicted as examples. The disclosure incorporates the embodiments that are depicted as examples, and modification aspects attained by those skilled in the art on the basis of the embodiments. For example, the disclosure is not limited to combinations of components and/or elements depicted in the embodiments. The disclosure can be implemented with various combinations. The disclosure can have additional portions that can be added to the embodiments. The disclosure incorporates embodiments from which components and/or elements in the embodiment are omitted. The disclose incorporates embodiments that can be achieved by replacement or combination of components and/or elements in one embodiment and another embodiment. The disclosed technical scope is not limited to the description of the embodiments. It should be understood that some disclosed technical scopes are depicted by the description of claims, and further include all changes within the meaning and scope which are equivalent to the description of claims.

The disclosure in the specification, figures, and the like is not limited to the description of claims. The disclosure in the specification, figures, and the like incorporates the technical ideas described in claims, and further covers a wider variety of, and a wider range of technical ideas than the technical ideas described in claims. Therefore, without being bounded by the description of claims, various technical ideas can be extracted from the disclosure of the specification, figures, and the like.

What is claimed is:

1. A fuel cell system comprising:
a fuel cell that generates power by a chemical reaction between an oxidation gas and a fuel gas;
an oxidation gas supply apparatus configured to supply the oxidation gas to the fuel cell;
an oxidation gas flow path having an upstream side flow path forming a flow path of the oxidation gas flowing from the oxidation gas supply apparatus toward the fuel cell, and a downstream side flow path forming a flow path of the oxidation gas flowing from the fuel cell toward an exterior space open to an atmosphere;
an oxidation gas pressure sensor that measures a pressure inside the upstream side flow path; and
a controller configured to execute a water content estimation mode of estimating a water content in an oxidation gas flow path including the fuel cell, and a scavenging mode of lowering the water content in the oxidation gas flow path including the fuel cell, wherein
the controller includes:
a physical quantity acquisition unit that acquires a flow rate of the oxidation gas flowing through the fuel cell, and an oxidation gas pressure in the upstream side flow path;
a pressure loss calculation unit that calculates an oxidation gas pressure loss which is a pressure loss of the oxidation gas before and after flowing through the fuel cell on a basis of the oxidation gas pressure in the upstream side flow path and a pressure in the downstream side flow path;
a water content calculation unit that calculates the water content in the oxidation gas flow path including the fuel cell on a basis of the oxidation gas flow rate and the oxidation gas pressure loss; and
a scavenging control unit that controls the oxidation gas supply apparatus on a basis of the estimated water content in the scavenging mode,
the controller controls the oxidation gas supply apparatus such that a supply amount of oxidation gas by the oxidation gas supply apparatus becomes greater than or equal to an estimation start supply amount in the water content estimation mode, and
the estimation start supply amount is set to an amount greater than a supply amount of oxidation gas necessary for power generation by the fuel cell.

2. The fuel cell system according to claim 1, wherein the controller estimates each of a water content before scavenging which is a water content before execution of the scavenging mode, and a water content during scavenging which is a water content during execution of the scavenging mode.

3. The fuel cell system according to claim 2, wherein the scavenging control unit starts the scavenging mode in case where the water content before scavenging is greater than or equal to a scavenging start amount, and stops the scavenging mode in case where the water content during scavenging is less than a scavenging stop amount set to an amount smaller than the scavenging start amount.

4. The fuel cell system according to claim 3, wherein the scavenging control unit executes a strong scavenging mode of increasing output power of the oxidation gas supply apparatus in the scavenging mode in case where the water content during scavenging is greater than or equal to a switching amount set to an amount greater than the scavenging stop amount, and a change in the water content during scavenging is less than or equal to a switching value.

5. The fuel cell system according to claim 3, wherein the controller notifies that an abnormality has occurred in case where the water content during scavenging is greater than or equal to the scavenging stop amount, and a change in the water content during scavenging is less than or equal to an abnormality determination value.

6. The fuel cell system according to claim 2, wherein the scavenging control unit starts the scavenging mode in case where the water content before scavenging is greater than or equal to a scavenging start amount, and stops the scavenging mode in case where a change in the water content during scavenging is within a stop range.

7. The fuel cell system according to claim 1, wherein the controller estimates a water content at a time of non-power generation when the fuel cell is not performing power generation.

8. A fuel cell system comprising:
a fuel cell that generates power by a chemical reaction between an oxidation gas and a fuel gas;
an oxidation gas supply apparatus configured to supply the oxidation gas to the fuel cell;
an oxidation gas flow path having an upstream side flow path forming a flow path of the oxidation gas flowing from the oxidation gas supply apparatus toward the fuel cell, and a downstream side flow path forming a flow path of the oxidation gas flowing from the fuel cell toward an exterior space open to an atmosphere;
an oxidation gas pressure sensor that measures a pressure inside the upstream side flow path; and
a controller configured to execute a water content estimation mode of estimating a water content in an oxidation gas flow path including the fuel cell, wherein
the controller includes:
a physical quantity acquisition unit that acquires a flow rate of the oxidation gas flowing through the fuel cell, and an oxidation gas pressure in the upstream side flow path;
a pressure loss calculation unit that calculates an oxidation gas pressure loss which is a pressure loss of the oxidation gas before and after flowing through the fuel cell on a basis of the oxidation gas pressure in the upstream side flow path and a pressure in the downstream side flow path; and
a water content calculation unit that calculates the water content in the oxidation gas flow path including the fuel cell on a basis of the oxidation gas flow rate and the oxidation gas pressure loss,
the controller controls the oxidation gas supply apparatus such that a supply amount of oxidation gas by the oxidation gas supply apparatus becomes greater than or equal to an estimation start supply amount in the water content estimation mode, and
the estimation start supply amount is set to an amount greater than a supply amount of oxidation gas necessary for power generation by the fuel cell.

9. The fuel cell system according to claim 8, wherein
the controller has a storage unit that stores a map representing a correlation among the water content in the flow path of the oxidation gas including the fuel cell, the flow rate of the oxidation gas, and the pressure loss of the oxidation gas,
the water content calculation unit calculates the water content on a basis of the map, the flow rate of the oxidation gas and the pressure loss of the oxidation gas in the water content estimation mode, and
the controller corrects the map by considering that the water content is the lowest when the fuel cell is not generating power and the fuel cell is dry, in the water content estimation mode.

10. A fuel cell system comprising:
a fuel cell that generates power by a chemical reaction between an oxidation gas and a fuel gas;
an oxidation gas supply apparatus configured to supply the oxidation gas to the fuel cell;
an oxidation gas flow path having an upstream side flow path forming a flow path of the oxidation gas flowing from the oxidation gas supply apparatus toward the fuel cell, and a downstream side flow path forming a flow path of the oxidation gas flowing from the fuel cell toward an exterior space open to an atmosphere;
an oxidation gas pressure sensor that measures a pressure inside the upstream side flow path; and
a controller configured to execute a water content estimation mode of estimating a water content in an oxidation gas flow path including the fuel cell, wherein
the controller includes:
a physical quantity acquisition unit that acquires a flow rate of the oxidation gas flowing through the fuel cell, and an oxidation gas pressure in the upstream side flow path;
a pressure loss calculation unit that calculates an oxidation gas pressure loss which is a pressure loss of the oxidation gas before and after flowing through the fuel cell on a basis of the oxidation gas pressure in the upstream side flow path and a pressure in the downstream side flow path;
a water content calculation unit that calculates the water content in the oxidation gas flow path including the fuel cell on a basis of the oxidation gas flow rate and the oxidation gas pressure loss; and
a storage unit that stores a map representing a correlation among the water content in the flow path of the oxidation gas including the fuel cell, the flow rate of the oxidation gas, and the pressure loss of the oxidation gas,
the water content calculation unit calculates the water content on a basis of the map, the flow rate of the oxidation gas and the pressure loss of the oxidation gas in the water content estimation mode, and
the controller corrects the map by considering that the water content is the lowest when the fuel cell is not generating power and the fuel cell is dry, in the water content estimation mode.
